(19) United States
(12) Patent Application Publication
(10) Pub. No.: US 2006/0257657 A1
(43) Pub. Date: Nov. 16, 2006

(54) Nanotube based non-linear optics and methods of making same

(76) Inventors: Seamus Curran, Troy, NY (US); Pulickel Ajayam, Troy, NY (US); Amanda Ellis, Auckland (NZ); Ganapathiraman Ramanath, Troy, NY (US)

Correspondence Address: FOLEY AND LARDNER LLP;SUITE 500, 3000 K STREET NW, WASHINGTON, DC, 20007, US

(21) Appl. No.: 10/537,942

(22) PCT Filed: Dec. 9, 2003
(86) PCT No.: PCT/US03/38748

§ 371 Date: Jun. 22, 2006

Related U.S. Application Data
(60) Provisional application No. 60/432,089, filed on Dec. 10, 2002.

(51) Int. Cl. B32B 9/00; B32B 19/00

(52) U.S. Cl. 428/367; 428/408; 428/357; 428/364; 428/372

(57) ABSTRACT

A non-linear optical active material for a non-linear optical device includes a matrix material, such as a polymer matrix material, carbon nanotubes dispersed in the matrix material, and chromophores having non-linear optical properties, such as organic dye molecules, attached to defect sites on the carbon nanotubes.

### CROSS-REFERENCE TO RELATED APPLICATIONS

This application claims priority to U.S. Provisional Application Ser. No. 60/432,089, filed Dec. 10, 2002, the disclosure of which is incorporated by reference herein in its entirety.

### FIELD OF THE INVENTION

The present invention is directed to nanotube based non-linear optics and methods of making thereof.

### BACKGROUND OF THE INVENTION

Carbon nanotubes (CNTs) are self-assembled coaxial cylindrical graphene sheets of sp² hybridized carbon atoms. There are two types of CNTs, multi-walled carbon nanotubes (MWNT) and single-walled carbon nanotubes (SWNT).

Many materials have been proposed as suitable for non-linear applications. These include inorganic materials such as gallium arsenide and lithium niobate. These inorganic materials make it possible to manufacture multilayer integrated optical circuits by techniques already tried and tested on electronic integrated circuits. However, processing inorganic materials is comparatively expensive and inorganic non-linear materials must often be grown in form of monocrystals to achieve desired non-linear properties.

Organic materials allow much faster signal processing than the inorganic materials, because of their much greater rate of change of state and ease of hybridization change. For example, organic materials are ideal for optical modulators. It is possible to reduce the control voltage and the length of interaction between the light wave and the control electric field thereby allowing easier use and a greater flow of information.

The polymers which may be used in non-linear optics are generally composed of a carbon skeleton onto which optically non-linear side groups or chromophoric groups are attached. In order for the material to be active in non-linear optics, it must be oriented so as to render the medium non-centrosymmetric. However, as orientation can lead to time dependent instabilities (samples degrade over time), these materials, in a practical sense, are unsuitable.

In general, extensive research has been carried out on organic and polymer systems over the last decade to determine optimum optical and electrical properties for possible electronic and opto-electronic applications. Progress towards producing polymeric materials in a robust opto-electronic fashion creates a host of problems which include sensitivity to intensity (power) within the polymer, long term instabilities due to photo-chemical effects, low thermal and electrical conductivity (necessary for transport related functions), and relatively low third order effects. Novel approaches to property tailoring in polymer systems are desirable to maximize the beneficial properties of the polymers while reducing their inherent deficiencies.

### SUMMARY OF THE INVENTION

A non-linear optical active material for a non-linear optical device comprises a matrix material, carbon nanotubes dispersed in the matrix material, and chromophores having non-linear optical properties attached to defect sites on the carbon nanotubes.

### BRIEF DESCRIPTION OF THE DRAWINGS

FIG. 1 shows a charge-transfer complex formation between carboxylated multi-walled carbon nanotubes (MWNTs) and phenosafranin (PSF).

FIG. 2 shows the UV-visible spectra of pristine MWNTs, acid treated MWNTs, and acid treated MWNTs after PSF dye attachment.

FIGS. 3A and 3B show normalized Raman spectra at different stages of nanotube functionalization.

FIGS. 4A and 4B are AFM images of a single multi-walled nanotube with dye attachments on defect sites.

FIGS. 5A and 5B are schematic illustrations of carbanion formation and subsequent initiation of charge transfer complex formation.

FIGS. 6 and 7 are SEM images of nanotubes embedded in a polymer matrix.

FIG. 8 is an SEM image of nanotubes aligned along the polymer fiber stretching direction.

### DETAILED DESCRIPTION OF THE PREFERRED EMBODIMENTS

The following describes certain preferred embodiments of the invention. It should be understood that this description is intended merely to be exemplary of the invention.

The present inventors have realized that chromophores or side attachments having non-linear optical properties attached to defect sites on carbon nanotubes provides a base material for non-linear optics that is more stable than previously used r conjugated systems.

A SuperNanoMolecular (SNM) structure is comprised of single or multi-walled carbon nanotubes and side attachments. The activity of SNMs in non-linear optics originates from the unusual combination of the nanotubes (SWNT or MWNT) and side attachments at the defect sites. These side attachments that come in the form of organic materials, such as polymers, oligomers, monomers, dimers, organic molecules (such as dye molecules), and inorganic materials, such as atomic nanoclusters, nanowires, colloids and nanoparticles (such as quantum dots), which are defined here as chromophores. Chromophores are any structural unit whose interaction with the electromagnetic field of radiation (UV, visible and IR) generates the desired optical effect. This effect can take place at resonant or non-resonant wavelengths. The activity of these chromophores in non-linear optics is given by their hyperpolarizability. These chromophores possess strong non-linear and/or luminescent optical properties. These properties then enhance the SuperNanoMolecular (SNM) structure's ability to act as the active optical component for non-linear applications. The particular chromophores may be selected for their non-linear optical properties required in the non-linear optical device. Preferably, the chromophores comprise organic molecules, such as dye molecules, attached to nanotubes. These molecules can be used to create strong dipoles that enhance the material's non-linear optical properties. Preferably, the SNM structure is non-centrosymmetric.

Thus, the presence of the SNM structures enhances non-linear optical properties and also enhances stability of the composite while considering the effects of high power laser coupling for waveguiding or transmission. The presence of the nanotubes in the formation of the SNM's also allows the use stronger optical fields with a reduced degradation effect from those optical fields.

The SNM structures are then mixed with or otherwise incorporated into a matrix material by any suitable method. These SNMs, when incorporated into a matrix material, such as a polymer matrix, provide flexible, durable and enhanced performance optical components, such as non-linear optical active material for organic non-linear systems. The polymer matrix is used as a protective and holding matrix as well as for alignment of the nanotubes themselves.

Preferably, the non-linear optical active material has a controlled morphology. For example, interfacial polymerization may be used to align the nanotubes so that the SNMs are morphologically and hence opto-electronically controlled in film and fiber production. The use of interfacial polymerization allows fibers and thin films to be produced over any surface.

In another example, the morphology of the SNMs in the non-linear optical active material is controlled by controlling the functionalization, which in turn allows control of the active or defect sites along the nanotube body to take away the randomness of attaching chromophores to the nanotube to form the SNMs.

Thus, one advantage of the SNMs is the ability to control the morphology of the non-linear system. This control allows the system to minimize dispersion and scattering of optical signals. While nanoparticles and other molecules have been attached to nanotubes in the prior art, there is no ability to properly control the morphology of the resulting structure. Thus, in the prior art, random attachments of molecules or nanoparticles to the nanotubes are made in a non-controlled manner. In contrast, the preferred methods of the present invention allow control of the amount of functionalization of the nanotubes and the attachments to the nanotube body.

While nanotubes in themselves, whether in a composite or on their own may have a non-linearity, using nanotubes in a composite alone may be insufficient to produce the desired non-linear effect due to lower non-linear responses, as well as having no control on the scattering. In contrast, the preferred embodiments of the present invention allow a collective enhancement of the region occupied by the SNM within a polymer (forming the composite) while controlling the morphology. The preferred methods of the present invention also allow control the amount of bundling that occurs in the nanotubes (either SWNT or MWNT) in a non destructive manner.

The above described non-linear active materials comprising the SNMs in matrix may be used in any suitable non-linear optical device. The particular chromophores are selected depending on the non-linear optical device that the active material is incorporated into. For example, the non-linear optical devices may be used in particular in the fields of optical signal telecommunications, information technology and optical signal processing. For example, the active materials may be used in harmonic generators, frequency translation or mixing devices, optical memories, optical modulators, optical amplifiers, optical switches, directional couplers and waveguides with non-linear properties and other similar optical and electro-optical devices.

One means of addressing some of the deficiencies of polymers in an electronic manner is the dispersion of nanostructures to create a polymer matrix that derives its electronic behavior from cooperative behavior between the host and additive. Nanotubes have only recently been used as electrical or mechanical inclusions in a polymer matrix because of the difficulty in achieving efficient dispersion. This difficulty is primarily due to the non-reactive surface of pristine nanotubes. The present inventors believe that the first solubility for nanotubes in a polymer matrix was reported only several years ago where the polymer used (PmPV) also acted as a filter for nanoparticles, resulting in a more purified sample of polymer and nanotubes in a composite. However, intrinsic van der Waals attractions among tubes, in combination with their high surface area and high aspect ratio, often leads to significant agglomeration, thus preventing efficient transfer of their superior properties to the matrix.

The methods of the embodiments of the present invention provide methods of reducing the nanotube aggregation effect and dispersing the nanotubes in a more ordered fashion to enhance the overall macro properties of the host polymer. The methods of the embodiments of the present invention also provide flexible, durable and enhanced performance of organic non-linear optical devices.

The preferred embodiments of the methods of making the active materials having non-linear optical properties for non-linear optical devices will now be described. The carbon nanotubes can be formed by any suitable method, such as HiPCO, arc discharge or CVD. If desired, the nanotubes may be purified through a variety of methods, including oxidative methodologies, such as ozone treatment, attachments with sulphonic acids, ultrasonification or simple plasma treatment. The resultant nanotubes are substantially free of amorphous materials and polyhedra. Most carbon nanotubes end up with ‘functionalized’ defect sites on the nanotube body. These sites can be in the form of structural defects (in the case of pentagon and heptagon formation or preferably by formation of bonding groups as will be described in more detailed below), or they can simply be sp³ formation and possessing dangling bonds. These susceptible or reactive defect sites serve as positions to bring other chromophores along and attach them to the nanotubes. These chromophores can be in the form of large complex polymers (from conjugated to non-conjugated systems) or small molecules, even in the case of atoms such as Se, simply colloidal type structures. The molecules that have strong photo-absorptive tendencies are attached onto the nanotubes, and this enhanced molecular structure can be used to tune the SNM structures for optical properties in order to enhance the optical photoconductive effect.

In a method of the first preferred embodiment, organic dye chromophore molecules are attached to defect sites induced on nanotubes, such as multi-walled carbon nanotube (MWNT) sites by an acid treatment. The acid treatment forms carboxyl groups on the nanotube defect sites. The carboxyl groups are used to covalently bind or chemisorb the dye molecules to the nanotubes.

In a preferred aspect of the first embodiment, a cationic phenazine dye, phenosafranin (PSF), is used. However, any other suitable dye may be attached to the nanotubes in a similar fashion. PSF is advantageous because it may be used in intense triplet-triplet non-linear optics, which may be used in optical bistable devices, such as flexible spatial light modulators. For example, PSF coupled with EDTA generates photovoltages of about 600 mV. In addition, PSF can undergo reversible reduction with long-lived excited states which make it a good photosensitizer in energy and electron transfer reactions. The amine functionalities make PSF suitable for dispersion in Nylon 6 or other similar polymer matrices, since the amine functionalities may be incorporated into Nylon 6 polymer backbone.

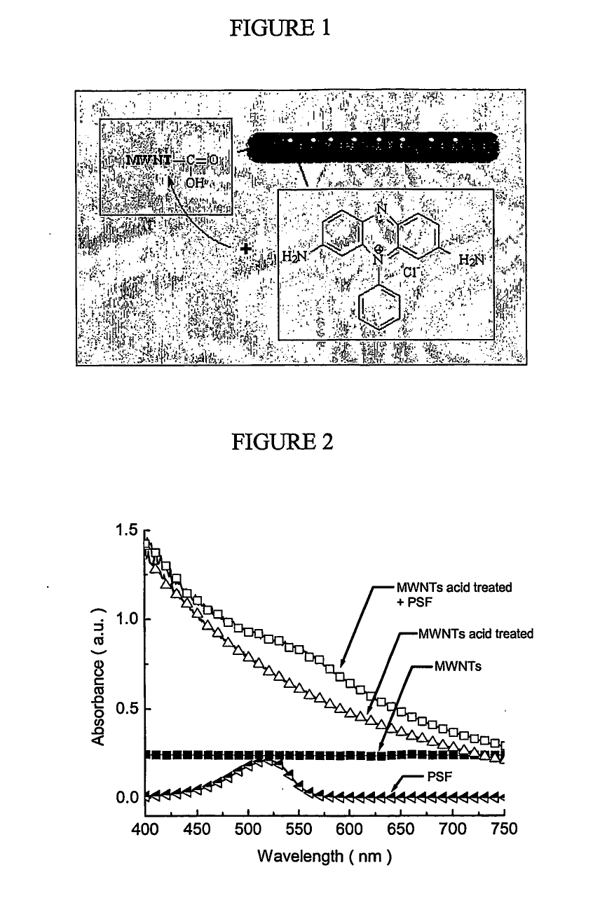

The following specific but non-limiting example of the method of the first embodiment is presented for illustration of the method. MWNTs synthesized by the arc-discharge method were first purified by sonication in concentrated 70/30 H₂SOHO₃ in an ultrasonic bath for 6 hours. Other acids and purification methods may also be used. The nanotubes were then filtered through a Whatman nylon microfilter, 0.20 μm, and washed with deionized water. This method of chemical functionalization creates dangling bonds that are progressively oxidized depending upon the intensity of treatment to hydroxyl (—OH), carbonyl (>C═O) and carboxyl groups (—COOH). Synthesis of phenosafranin (3,7-diamino-5-phenylphenazine or PSF) functionalized MWNTs was achieved by mixing 3 mg of carboxylated nanotubes in 5 mL of deionized water containing 0.1% v/v PSF, as schematically illustrated in FIG. 1. After mixing, the solution was sonicated for 1 minute. While the carboxylated tubes appeared soluble in deionized water, after the addition of the PSF there is a notable change in their solubility as the nanotubes segregate from the solution, a clear indication of PSF attachment. The product was filtered under vacuum through a 0.2 μm nylon microfilter and washed thoroughly with deionized water, then air-dried and stored in a desiccator.

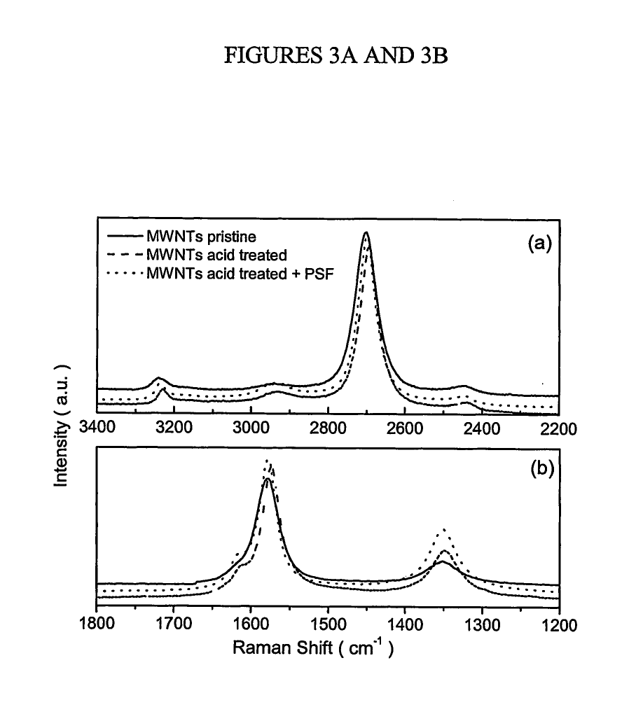

FIG. 2 illustrates UV-Visible absorption spectra (plots of absorbance versus wavelength) of PSF, pristine MWNTs, acid treated MWNTs and acid treated MWNTs after PSF dye attachment. Notably, Mie scattering is observed after acid treatment of the tubes (compared to the pristine tubes), characterized by the rapid increase in base line at decreasing wavelengths. Without wishing to be bound by a particular theory, the present inventors believe that this phenomenon is caused by the acid treatment creating shortened tubes of similar length scales and electrical characteristics such that they can separate or disperse different wavelengths of light.

The absorption maximum for PSF is at 520 nm (2.38 eV) while the absorption maximum for the broad band of PSF treated carboxylated nanotubes is 562 nm (2.21 eV), a shift of 0.17 eV (FIG. 2). Without wishing to be bound by a particular theory, the present inventors believe that this bathochromic or red-shift indicates chemisorption, primarily due to the phenosafranin/MWNT interaction which allows excitation transfer (caused by light) from the phenosafranin dye to the nanotube, and visa versa. This would indicate that the bond formation or charge transfer process is far stronger than a simple electrostatic process. Carbon nanotubes, in general, are believed to be good electron acceptors. In this case, it is believed that the dye has attached to the nanotube. The result is that there is a drop in the dye molecules Homo-Lumo gap due to the electron transfer process. Consequently, a decrease in vibrational freedom inflicted by the new charge transfer process takes place as valence electrons are transferred from the PSF attached molecule into the carbon π* band.

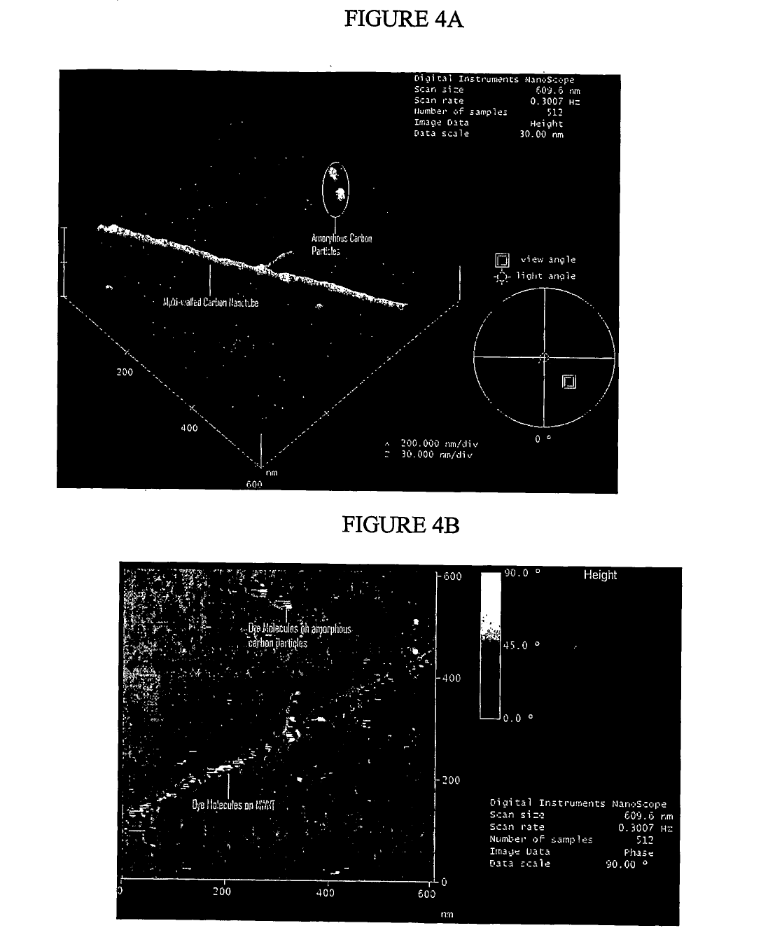

FIG. 3 shows normalized Raman spectra at different stages of the nanotube functionalization (pristine nanotubes, acid treated nanotubes (i.e., carboxylated), and PSF and acid treated nanotubes). The functionalized MWNTs are characterized by Raman spectroscopy using a Ar⁺ laser operating at 514.7 nin. The spectra shows two main characteristic first order peaks for the MWNTs. The Raman peak of the E_{2g} optical phonon is observed at 1580 cm⁻¹ and is believed to be due to in-plane vibration of a graphite layer (G mode) (FIG. 3B). The peak at 1350 cm⁻¹ is believed to be a disorder induced D mode resulting from impurities and lattice distortions in CNT's. Without wishing to be bound by a particular theory, the present inventors believe that as the perfect 2-D graphitization of the MWNTs is altered to a more disordered structure upon acid treatment, a strain is introduced in the C═C bond vibrations which gives rise to an increase in the intensity of the D peak. In addition the D peak narrows as more amorphous carbon and polyhedra are removed from the sample. Due to the acid treatment, the E_{2g} peak splitting is observed, with the G peak downshifted by 5 cm⁻¹, from 1581 cm⁻¹, and a new peak appearing at 1617 cm⁻¹, denoted D′ resolving (FIG. 3B). Without wishing to be bound by a particular theory, the present inventors believe that this peak can be associated with defects arising from the nanotube body, as observed through plasma treatment elsewhere. Without wishing to be bound by a particular theory, the present inventors believe that the step of adding PSF removes many of the acid activated sites on the graphene outer layer of the MWNT's, as the MWNT outer layer attracts the PSF to the surface, and through self-assembly PSF-CNT functionalization occurs. Consequently, the D′ peak is reduced in intensity as the PSF sits on the acid treated reactive sites of the nanotubes.

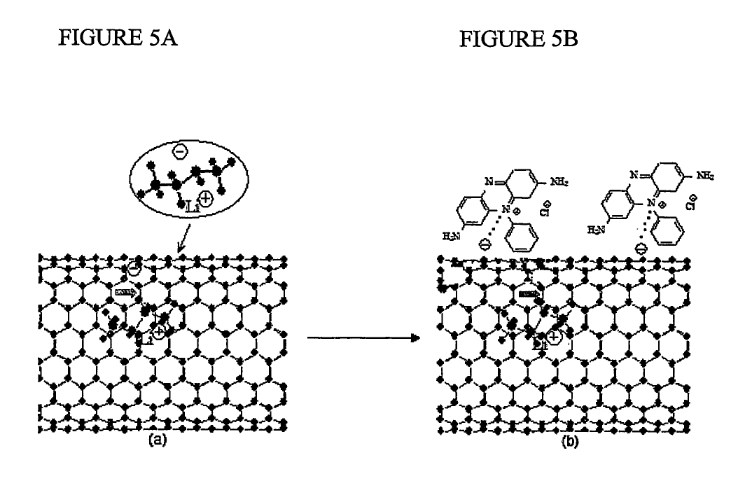

FIGS. 4A and 4B are AFM images of PSF dye and acid treated nanotubes. FIG. 4A is a height image (deflection) showing no apparent change in height on the locations of dye molecules. FIG. 4B is a phase image showing clear contrast on regions of dye attachments at defect sites on the MWNT. A Digital Instrument Multimode Scanning Probe Microscope with a Nanoscope IIIa controller was used to image the nanotubes and dye attached nanotubes. Phase imaging, in tapping mode, using an oscillating probe was used to obtain nanometric images. This goes beyond topographic details to measure changes in surface properties such as composition, adhesion, hardness, viscoelasticity, and more, by mapping the change in the phase of the cantilever oscillations. Samples for AFM measurements were prepared by drop-casting the solution of nanotubes dispersed in water onto a freshly cleaved highly oriented pyrolytic graphite (HOPG) substrate. This was then dried in air until the water has evaporated, leaving only nanotubes on the HOPG substrate. While no large change in topography could be observed at the sites of the dye attachment (FIG. 4A), attributed to the sub-nanometer size of the dye molecules, a more prominent contrast was detected in the phase-image (FIG. 4B) at locations where the dye molecules were attached to defect sites on the nanotubes. This is as would be expected if the dye molecules in self-assembly attach only at CNT defect sites. In the Phase image, minimal contrast is observed between the HOPG substrate and the multi-walled nanotubes owing to the similar graphitic nature of both materials. However, at locations where dye molecules are attached to the tube, the PSF material that is attached to the nanotube is visible. However, MWNT coverage is not complete as the PSF only adheres to acid activated defect sites, and consequently there is not aggregation of the dye on the entire length of the nanotube body.

The results in FIGS. 2, 3 and 4 show that phenosafranin (PSF) attaches to MWNT at acid treatment induced defects along the nanotube body. The attachment of the organic dye PSF was achieved through the process of self-assembly whereby the dye attaches on top of these induced defect sites. Spectroscopic verification using UV-Visible and Raman spectroscopy showed a bathochromic shift in the UV-Visible spectrum indicative of an electron transfer process between the nanotubes and PSF. In addition, the changes in the nanotube morphology were spectroscopically fingerprinted as being due to self-assembly, indicated by changes in the D, G and D′ vibrational position of the Raman spectra. Finally, using AFM, in tapping mode and Phase image control, the carbon nanotubes and the attached PSF were distinguished. It believed that the attachment was selective in that the only positions available for self-assembly attachment were at the defect sites. This allows organic molecules, such as optoactive dyes, to alter the morphology and more concisely tailor the optical properties of nanotubes to meet more specific needs, optically, electronically or biomedically.

A method of the second preferred embodiment will now be described. In this method, organic dye chromophore molecules are attached to defect sites induced on single-walled carbon nanotube (SWNT) sites by an anionic initiator (i.e., ionization agent) in an anionic treatment. The carbon nanotubes are reacted with an anionic initiator thereby generating anions (i.e., defect sites) on the surface of the carbon nanotubes. The organic molecules are covalently bonded to the anions. Specifically, this method introduces carbanions onto the single or multi-wall nanotube surface by treatment with an anionic initiator, such as sec-butyllithium. This method serves to exfoliate, separate and negatively charge the nanotube bundles providing a high density of initiating sites for cationic phenazine dye attachment.

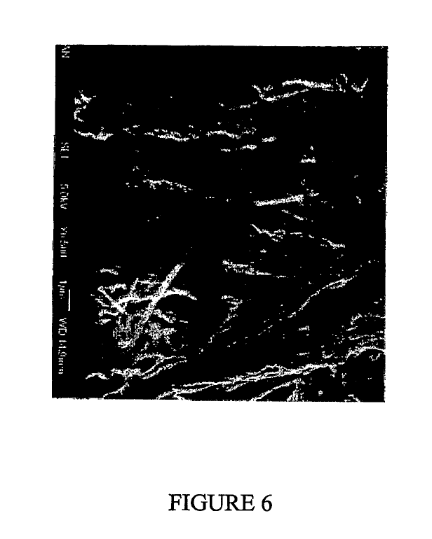

FIGS. 5A and 5B are schematic illustrations of carbanion formation and subsequent initiation charge transfer complex formation. FIG. 5A illustrates a section of SWNT sidewall showing sec-butyllithium addition to a double bond (large arrow indicates the bond to which it adds) and formation of anion via transfer of charge. FIG. 5B shows how the carbanion transfers the negative charge to cationic phenosafranin (i.e., PSF formed from a chloride salt).

The anionic process of the second embodiment of the invention involves the use of an ionizing agent or anionic initiator. An anionic initiator is any agent which can add to double bonds on the nanotube surface thereby generating anions (carbanions) on the surface of the nanotubes. Anionic initiators include, for example, metal organic initiators such as alkyl lithium compounds (salts), such as sec-butyllithium, as well as other alkali metal organic compounds, such as fluorenyl-sodium and cumyl-sodium. Radical ionic initiators such as sodium naphthalenide may also be used.

In one aspect of the second embodiment, anions that are formed on the surface of the nanotubes using the anionic process are subsequently quenched (i.e., protonated) with an alcohol (e.g., methanol or ethanol). The resulting nanotubes may be considered to be derivatized by virtue of the fact that the ionizing agent which has added to the nanotube double bond is still attached. When the anionic initiator used is an alkyl lithium salt, for example, the derivatized, well-dispersed nanotubes are alkyl-derivatized, well-dispersed nanotubes. For example, the defect sites may comprise C₁₋₆ alkyl groups. Thus, if sec-butyl lithium is used as the anionic initiator, the nanotubes will have sec-butyl groups attached to their surface. In short, the skilled artisan will appreciate that the nanotube surface will comprise the anionic initiator attached thereto at the defect sites, even when the resulting anion is subsequently reacted with the cationic dye.

In the context of derivatized, well-dispersed CNTs, “derivatized” and “well-dispersed” have the following meaning. “Well-dispersed” means that the nanotubes are substantially homogeneously distributed (i.e., allowing for a 1 to 20 percent, preferably 1 to 5 percent inhomogeniety in certain regions of the matrix) in the matrix without phase separation. Preferably, a majority of the well dispersed CNTs are not bundled together. Preferably, about 60%, more preferably about 80%, most preferably about 90% of the derivatized, well-dispersed CNTs are not bundled together. “Derivatized” means that the derivatized, well-dispersed CNTs contain bonding groups on their surface. An example of a bonding group in the context of the second embodiment of the present invention is a C₁₋₆ alkyl group.

The following specific but non-limiting example of the method of the second embodiment is presented for illustration of the method. HiPCO single wall carbon nanotubes (SWNTs) were obtained from Carbon Nanotechnologies Inc. (Houston, USA). The tubes have an average length around 1 μm and the predominant impurities are iron catalyst particles (5-6 at. %). To ensure that the nanotubes are free of air and absorbed moisture prior to derivatization, they were dried under dynamic vacuum (10-3 torr) at 200° C. for 12 hours and subsequently stored under argon. SWNTs produced by the HiPCO process, were used without further purification, as purification procedures might introduce functionalities that hinder carbanion formation.

An alkyllithium, R(−)Li(+) (e.g. sec-butyllithium) in a slight excess amount sufficient to remove protic impurities on the SWNT surface is reacted with dried SWNTs dispersed by sonification in a solvent, such as purified cyclohexane, to induce the formation of carbanions in the carbon nanotubes and thereby grafting the alkyl groups onto the SWNT surface. During this process, the SWNTs are well-dispersed/debundled due to the electrostatic repulsion between negatively charged SWNTs during the reaction. Since bundling of SWNT no longer exists, the reaction solution remain homogenous. The SWNTs are suitable for attachment of the dye molecules having non-linear optical properties, as illustrated in FIG. 5B and as described in the method of the first embodiment. Alternatively, a polymer chromophore may be attached to the SWNTs by adding suitable chromophore monomers to the SWNT containing solution and having the free sec-butyllithium and/or the SWNT carbanions initiate polymerization. A general method of attaching polymers to nanotubes by anionic polymerization is described in G. Viswanathan, et al., J. Am. Chem. Soc. (2003) 125, 9258-59, in U.S. Provisional Application 60/427,097, filed Nov. 18, 2002, and in PCT Application filed Nov. 18, 2003 titled NANOTUBE POLYMER COMPOSITE AND METHODS OF MAKING SAME, naming Pulickel Ajayan et al. as the inventors and which claims priority to the 60/427,097 provisional application, the disclosures of which are incorporated by reference herein in their entirety. Degassed protic alcohol, such as methanol and/or butanol, is optionally added to quench by protonation those carbanions to which no dye molecules attached.

In an alternative aspect of the second embodiment, the anionization method may be used to form carboxyl groups at the defect sites on the nanotubes. In this case, an anionic initiator is reacted with the nanotubes to induce the formation of anions on the nanotubes surface. The reaction mixture is then treated with a degassed, protic alcohol such that any remaining anions are quenched in a controlled manner. The nanotubes comprising the anions are then reacted with dry and oxygen free carbon dioxide gas to form CO₂H-derivatized, well-dispersed nanotubes, which are then dried.

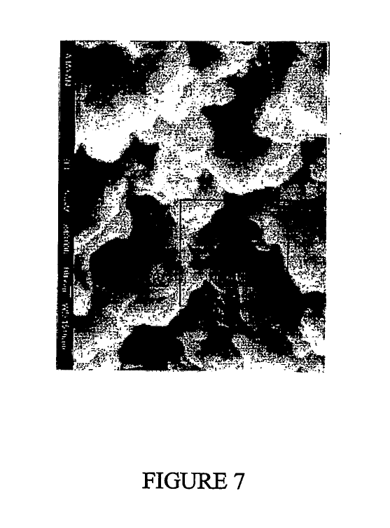

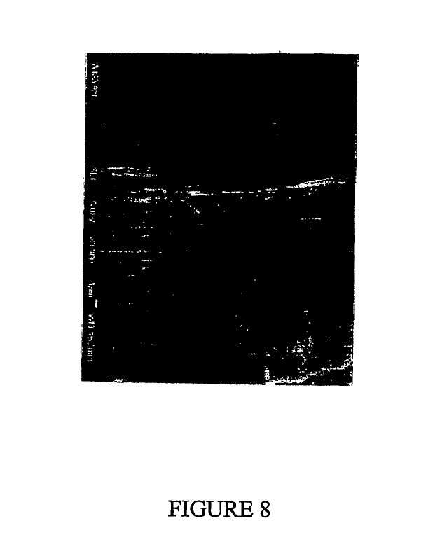

The organic dye molecules attached to the carbon nanotubes by the methods of the first or second preferred embodiments described above may be incorporated into a matrix, such as the polymer matrix by any suitable method. For example, the incorporation may be accomplished by either by mixing pre-formed polymers with the nanotube-dye structures in a common solvent or by dissolving the nanotube-dye structures in the monomer and subsequent polymerization. In the former method, for example, nanotubes are dissolved in toluene, along with a pre-formed polymer such as poly(methyl methacrylate). The dispersion is then precipitated using an antisolvent such as methanol to yield polymer nanotube composites. Alternatively, the nanotube-dye structures are dissolved in a monomer and subsequent polymerization, such as interfacial or suspension polymerization, is carried out to incorporate the nanotube-dye structures in the matrix. For example, for a nylon matrix, the process would be as follows. The nanotube-dye structures are dissolved in an organic phase containing dicarboxylic acid chloride, and diamine is dissolved in water. The two non-miscible liquid layers are superposed to yield a polyamide-nanotube composite at the interface, which is constantly pulled out (i.e., interfacial polymerization) to form a sheet or thread (i.e., fiber) shaped matrix. For example, FIGS. 6 and 7 are SEM images of nanotubes embedded in a polymer matrix while FIG. 8 is an SEM image of nanotubes aligned along the polymer fiber stretching direction.

In general, the polymer matrix formation may optionally include solubilizing the nanotube structures with another organic material to form a suspended phase, and reacting with another organic component to produce a polymer surrounding the aligned nanotubes. The composite may then be formed in the morphological manner of a thin film, a thread or fiber, a web and/or a suspended but soluble or insoluble pellet for future morphological and device applications.

If desired, the aligned nanotubes can be optionally mixed with another organic solvent, that solvent using weak interactions such as van der Waals forces to maintain solubility, or mixed with an organic solvent containing a diacid or amine. The polymerization may follow pretreatment of one component of the polymerization step with carbon nanotubes. If desired, the alignment of the nanotubes within the polymer matrix may be used as a factor for morphological design and applications.

In general, organic molecules with specific absorptive tendencies, such as the organic dye molecules, are attached to the functionalized defect sites of the nanotubes. If it is desirable to align the nanotubes in the polymer matrix, then these treated molecules (SuperNanoMolecular (SNM) nano-structures) are then preferably embedded into a solution where interfacial polymerization occurs, and the nanotubes are aligned. The coatings that form the SNM structure are preferably covalently bound to the nanotubes. However, hydrophobic or electrostatic binding and even binding by van der Waals forces to keep the differing molecular structures in place may be used.

Furthermore, if desired, different types of chromophores may be attached to the carbon nanotubes, wherein the different types of chromophores have a peak sensitivity to different radiation wavelengths. This device, is more sensitive to different radiation wavelength bands.

Any suitable organic or inorganic chromophore may be used. For example, a cationic phenazine dye, such as PSF was described as the chromophore in the specific examples above. However, other suitable chromophores may be used. For example, polymers, oligomers, monomers, dimers, organic molecules (such as other dye molecules), metal or semiconductor atomic nanoclusters, metal or semiconductor nanowires, colloids, such as Se atoms and nanoparticles (such as metal or semiconductor quantum dots) may be used as chromophores. The non-linear materials may have second (χ²) or third (χ³) order non-linearity, depending on the desired applications. For example, second order non-linear materials can be used in thin film form, with the thin film having electrodes through which an optical beam can pass through and be deflected, depending on the non-linear optical material. Third order non-linear materials can be used for waveguiding and optical switching in thin film or fiber form. Specifically, the chromophores described in U.S. Pat. Nos. 4,985,528; 5,384,378; 5,290,824; 5,231,140; 5,294,463 and 5,266,651 may be used.

If desired, optional functional groups which act as a linker or bridge between the defect site on the CNT and the chromophores may be added to the SNM structures. These functional groups may be used to attach chromophores, such as polymer, monomer or dimer chromophores to the defect sites on the CNT surface. The functional groups may comprise OH or NH₂ groups. For example, the oxygen atom of the OH group may be attached to the C₁₋₆ alkyl defect site on the nanotube. The functional groups also help debundle/disperse CNTs by providing steric bulk and/or electrostatic repulsions between functional groups on adjacent CNTs. The functional groups provide sites on the CNTs to which polymer and other chromophores may be grafted.

Non-limiting examples of agents that place functional groups attached to the anion defect sites on a CNT surface include ethylene oxide and X(alk)NRR′ (where X is Br or Cl, alk is a C₁₋₆ alkyl chain and R and R′, together with the nitrogen to which they are attached, form a 2,2,5,5-tetralkyl-2,5-disilacyclopentane ring). The NRR′ group may be converted to an NH₂ group by methods well known in the art (e.g., 1% HCl solution).

Any suitable polymer matrix material may be used. Polymer matrices that are contemplated by an embodiment of the invention include, without limitation, a polyamide, polyester, polyurethane, polysulfonamide, polycarbonate, polyurea, polyphosphonoamide, polyarylate, polyimide, poly(amic ester), poly(ester amide), a poly(enaryloxynitrile) matrix or mixtures thereof. In another embodiment, the matrix is a poly(ester amide)s related to nylons and polyesters 6,10 or 12,10. For example, poly(ester amide)s may comprises copolymers, such as poly(butylene adipate)-co-(amino caproate). In still another embodiment, the matrix is selected from the following polymers or mixed polymers: polycarbonate/polybutylene terphthalate (PC/PBT), polycarbonate/polyethylene terephthalate (PC/PET), polyamide (PA) reinforced with modified polyphenylene ether (PPE), polyphenylene suphide (PPS), polybutylene terephthalate (PBT), polyethylene terephthalate (ET), polyetherimide, expandable polystyrene poly(2,6-dimethyl-1,4-phenylene ether (PPE), modified polyphenylene ether (PPE), polycarbonate (PC), acrylic-styrene-acrylonitrile (ASA), polycarbonate/acrylonitrile-butadiene-styrene (PC/AILS) and acrylonitrile-butadiene-styrene (ABS), or mixtures thereof.

The structures (i.e., the component parts) of the non-linear optical devices, such as the harmonic generators, frequency translation or mixing devices, optical memories, optical modulators, optical amplifiers, optical switches, directional couplers, waveguides with non-linear properties and other similar optical and electro-optical devices which contain the active non-linear optical materials described above are known and are not reiterated here in detail besides the illustrative examples provided below.

For example, an electro-optical switch based on an interference modulator principle comprises an optical path which splits into two branches. The active non-linear optical material is located in one of the branches. A voltage source applies a voltage to the active non-linear optical material to change the phase of the radiation passing through the material by one half wavelength. The output of the branches is combined in a second optical path. When the voltage is applied, the output from both branches cancels each other out due to the destructive interference, creating a zero output from the switch. When no voltage is applied, the output from both branches is combined constructively, creating a one output from the switch.

An directional electro-optical switch is based on the reflection/transmission principle. The non-linear active optical material is positioned at an “X” junction of two waveguides. An applied voltage causes a change in the non-linear material refractive index which causes radiation propagating through the lower left path to reflect from the non-linear material and to continue through the upper left path. When no voltage is applied, radiation propagating through the lower left path is transmitted through the non-linear material and out through the upper right path.

An example of an all optical switch or amplifier is a non-linear material waveguide in which a pump beam is combined with a probe beam. The pump beam may cause amplification of the probe beam, such as Raman amplification, or the pump beam may cause the probe beam to be extinguished due to destructive interference or other effect.

An example of an optical memory is an optical flip-flop memory that is realized by coupling two non-linear optical elements, such as lasers, Mach-Zehnder interferometers or non-linear polarization switches, as described in Y. Liu et al. Proc. Symp. IEEE/LEOS Benelux Chapter (Amsterdam), 2002, pp. 199-202. The light from the first switch is provided into the second switch and vise-versa. The light from each switch acts as a saturating control signal that can suppress the light emitted from the other switch. The system operates as a memory because each respective switch suppresses the output of the other switch in different states. The state of the flip flop can be determined by observing the amount of light at the switch outputs. Each polarization switch mentioned in the above article comprises a logic AND gate, and is made from a laser source, a semiconductor optical amplifier, two polarization controllers and a polarization beam splitter. The semiconductor optical amplifier may be replaced by the non-linear optical active material of the preferred embodiments of the present invention.

Preferably, the non-linear optical device comprises a flexible sheet or thread (i.e., optical fiber) type device. In this case, the matrix material comprises a flexible thin film or a flexible thread that is formed on a substrate, and an overall stiffness of the device is determined by a stiffness of the substrate. Thus, by selecting an appropriate substrate or supporting surface, the stiffness of the non-linear device may be selected. The flexible, highly efficient optical devices, such as waveguides described above can be used on any surface or substrate. This would allow them to be applied to any surface, such as a curved, stepped or otherwise irregular surface without the cost of expensive mounts and cabling.

From the foregoing description, one skilled in the art can easily ascertain the essential characteristics of this invention, and without departing from the spirit and scope thereof, can make various changes and modifications of the invention to adapt it to various usages and conditions without undue experimentation. All patents, patent applications and publications cited herein are incorporated by reference in their entirety.

What is claimed is:

1. A non-linear optical active material for a non-linear optical device comprising:
a matrix material;
carbon nanotubes dispersed in the matrix material; and
chromophores having non-linear optical properties attached to defect sites on the carbon nanotubes.

2. The material of claim 1, wherein the chromophores are selected from a group consisting of polymers, oligomers, monomers, dimers, organic molecules, atomic nanoclusters, nanowires, colloids and nanoparticles.

3. The material of claims 1 or 2, wherein the chromophores are chemisorbed to the defect sites on the carbon nanotubes.

4. The material of claims 1, 2 or 3 wherein the chromophores comprise organic dye molecules.

5. The material of claim 4, wherein the organic dye comprises a phenazine dye.

6. The material of claim 5, wherein the organic dye comprises PSF.

7. The material of claims 1, 2, 3, 4, 5 or 6, wherein the defect sites on the carbon nanotubes comprise a carboxyl group or a C₁₋₆ alkyl group.

8. The material of claim 7, wherein the C₁₋₆ alkyl group comprises a sec-butyl group.

9. The material of claims 1, 2, 3, 4, 5, 6, 7 or 8, wherein:
the matrix material comprises a polymer matrix material; and
the carbon nanotubes are well dispersed in the polymer matrix material.

10. The material of claim 9, wherein the polymer matrix material is selected from a group consisting of polyamide, polyester, polyurethane, polysulfonamide, polycarbonate, polyurea, polyphosphonoamide, polyarylate, polyimide, poly(amic ester), poly(ester amide), a poly(enaryloxynitrile) matrix or mixtures thereof.

11. The material of any one of claims 1 to 10 further comprising different types of chromophores attached to the carbon nanotubes, wherein the different types of chromophores have a peak sensitivity to different radiation wavelengths.

12. The material of any one of claims 1 to 11, wherein:
the matrix material comprises a flexible thin film or a flexible fiber that is formed on a substrate; and
an overall stiffness of the non-linear optical active material is determined by a stiffness of the substrate.

13. The material of any one of claims 1 to 12, wherein the carbon nanotubes are aligned in a controlled manner in the matrix material.

14. The material of claim 1, wherein the SuperNanoMolecular structures comprising the carbon nanotubes with attached chromophores are non-centrosymmeteric.

15. The material of any one of claims 1 to 14, wherein the chromophores are covalently bound to a predetermined number of defect sites controllably arranged on the nanotubes.

16. The material of any one of claims 1 to 15, wherein the material has a controlled morphology.

17. A non-linear optical or electro-optical device comprising the non-linear optical active material of any one of claims 1 to 16.

18. The device of claim 17, wherein the device is selected from a group consisting of harmonic generators, frequency translation or mixing devices, optical memories, optical modulators, optical amplifiers, optical switches, directional couplers and waveguides.

19. The device of claim 17, wherein the non-linear optical active material is a thin film waveguide exhibiting a χ³ effect.

20. The device of claim 17, wherein the non-linear optical active material is a thin film exhibiting a χ³ effect incorporated into an optical switch.

21. The device of claim 17, wherein the non-linear optical active material is a thin film exhibiting a χ² effect incorporated into a device comprising thin film electrodes on the thin film, such that an optical beam can pass through the thin film and be deflected.

22. A method of making a non-linear optical active material, comprising:
forming defect sites on carbon nanotubes;
attaching chromophores having non-linear optical properties to the defect sites on the carbon nanotubes; and
incorporating the nanotubes and the chromophores into a matrix material.

23. The method of claim 22, wherein the chromophores are chemisorbed to the defect sites on the carbon nanotubes.

24. The method of claims 22 or 23, wherein:
the step of forming defect sites comprises reacting the carbon nanotubes with an anionic initiator thereby generating anions on the surface of the carbon nanotubes; and
the step of attaching chromophores comprises covalently bonding the chromophores to the anions.

25. The method of claim 24, wherein the anionic initiator comprises an alkyllithium salt.

26. The method of claim 25, wherein the alkyllithium salt is sec-butyllithium which forms sec-butyl groups on the carbon nanotubes.

27. The method of claims 22 or 23, wherein:
the step of forming defect sites comprises reacting the carbon nanotubes with an acid thereby generating carboxyl groups on the surface of the carbon nanotubes; and
the step of attaching chromophores comprises covalently bonding the chromophores to the carboxyl groups.

28. The method of claim 27, wherein the acid comprises a mixture of sulfuric and nitric acids.

29. The method of any any one of claims 22 to 28, wherein the step of incorporating the nanotubes and the chromophores into a matrix material comprises incorporating the nanotubes and the chromophores into a polymer matrix material.

30. The method of claim 29, wherein the polymer matrix material comprises a flexible polymer thin film or a flexible polymer fiber.

31. The method of claim 30, wherein the step of incorporating the nanotubes and the chromophores into the polymer matrix material comprises incorporating the carbon nanotubes and the attached chromophores into the polymer matrix material by interfacial polymerization.

32. The method of claim 31, wherein the polymer matrix material is selected from a group consisting of polyamide, polyester, polyurethane, polysulfonamide, polycarbonate, polyurea, polyphosphonoamide, polyarylate, polyimide, poly(amic ester), poly(ester amide), a poly(enaryloxynitrile) matrix or mixtures thereof.

33. The method of any one of claims 22 to 32, wherein the chromophores are selected from a group consisting of polymers, oligomers, monomers, dimers, organic molecules, atomic nanoclusters, nanowires, colloids and nanoparticles.

34. The method of claim 33, wherein the chromophores comprise organic dye molecules.

35. The method of claim 34, wherein the organic dye comprises PSF.

36. The method of claim 22, wherein the step of forming defect sites comprises controllably functionalizing the carbon nanotubes to controllably form the defect sites on the carbon nanotubes.

37. The method of claim 22, further comprising controlling a morphology of the non-linear optical active material.

38. The method of any one of claims 22 to 37, further comprising incorporating the non-linear optical active material into a non-linear optical device selected from a group consisting of harmonic generators, frequency translation or mixing devices, optical memories, optical modulators, optical amplifiers, optical switches, directional couplers and waveguides.
